(19) United States
(12) Patent Application Publication
(10) Pub. No.: US 2007/0222209 A1
(43) Pub. Date: Sep. 27, 2007

(54) Pipe Clamp for a Reinforcement Grid, Preferabley in Connection with Floor Heating Installations

(76) Inventors: Brian Rise, Skaelskor (DK); Tom Jonsson, Skaelskor (DK)

Correspondence Address: AKC PATENTS, 215 GROVE ST., NEWTON, MA, 02466, US

(21) Appl. No.: 11/575,146

(22) PCT Filed: Sep. 12, 2005
(86) PCT No.: PCT/DK05/00579

§ 371 Date: Mar. 28, 2007

(30) Foreign Application Priority Data
Sep. 13, 2004 (DK) PA200401386

(51) Int. Cl. F16L 3/02

(52) U.S. Cl. 285/148.17

(57) ABSTRACT

The present invention relates to a pipe clamp, in particular for the reinforcement grid in connection with the installation of floor heating, constructed as a very firm quadrangular block. The top of the pipe clamp is shaped so that it is prepared for the placing of the heat pipes in a bearing (4), arranged as two (arbitrary) on one another perpendicular cross bearings (4). The bottom of the the pipe clamp is shaped so that it is prepared for the placing on a reinforcement grid, arranged as two on one another perpendicular pipes cases (1), the depth and length of which are adapted to fit the cross mounted pipes of the reinforcement grid. The pipe clamp has a number of slits (3) in particular places centrally situated in the middle of each of the four sides of the pipe clamp and also in the very center of the pipe clamp. Hereby you achieve flexibility and avoid rigidity. The pipe clamp is placed most firmly at the cross fields of the reinforcement grid but it has an efficient clip-function and can therefore be placed steadily anywhere on the grid.

The present invention relates to a pipe clamp (a tube bracket) in particular for reinforcement grid preferably in connection with the installation of floor heating.

A pipe clamp which both is very easy and simple for the application procedure but also with respect to the ideal method of construction for the tool by the artful design and arrangement.

Today it is common practice to bind with a steel wire the pipes to the reinforcement grid with a pair of tongs.

You have the steel wire in one hand and a pair of binding tongs in the other. When mounting the pipes the erecting engineer must support his knee on the hard reinforcement grid.

Conditions which are troublesome and a strain on the body, in particular the knees.

The very process is much time consuming.

In spite of many attempts to simplify the process, the said procedure is still the most common procedure.

One can find many different types of pipe clamps described in the patent literature, the reason why none of these apparently is a common procedure can be many.

The present invention has many advantages both in respect to the simple procedure of the application and the stability of the pipe clamp.

Because the known pipe clamps are defective it is an obvious reason why it is not a common procedure to use pipe clamps at all.

Typically the applications have no particular advantages, they are to troublesome and the stability of the known pipe clamps are not sufficient.

This is also very much so for the inventions which seem comparable with the present invention.

DE 7921935 U1 consist of at least two pipe clamps placed together on a strip. These pipe clamps are mounted in a most inexpedient way because one first needs to place the pipe clamp kit on the floor and hereafter the reinforcement grid must be placed on top and adjusted to the respectively “Nuten”. It does not take much fantasy to imagine the difficulties that inevitably will occur—the distance between the cross fields of the reinforcement grid must measure exactly to the pipe clamps ditto. Patience, plenty of time, a well-developed motor function and fingerspitzgefull are minimum demands to the erecting engineer. The pipe clamps are not tight and stabile at the place named “Nuten” in the paper.

The construction is “clumsy” and the function is troublesome and very awkward to handle.

The method of construction in DE 8024216 U1 is lacking sturdiness. This simple but crucial factor implies that the hole arrangement becomes if not inapplicable then at least most awkward. Especially when the assembled is in positions outside the cross fields the missing stability is a major problem. The pipe clamp is mounted by means of a 2-forked fork which means that the container must be pressed in position on the grid from the side, a method which is more troublesome and unpractical than the procedure according to the present invention.

Because the former attempts failed to succeed it has been the aim of the present invention to produce a stable, flexible, and simple and easy method of construction. The present invention is a solid quadrangular block.

The quadrangularly shape of the block and probably also because of the deliberate choice of material—fx polyfiner.pom—provides a solid fundament for the layer of reinforcement grid, which must be placed on top of the first one.

The consequence is in general a better moulding because the pipes are not exposed to friction from the reinforcement bar.

The bottom of the blocks has two on one another perpendicular oblong half cylinder shaped crossing pipe cases foreseen to be pressed over the cross field of the reinforcement grid and the crossing pipes. In this way both pipes are individually placed in their respektive pipe cases.

The distance from the floor to the actual reinforcement bars is staggered, therefore the physical distance of the pipe cases from the floor is adjusted to these conditions in such a way that one pipe case is placed higher above the floor than the other. Hereby the pipe clamps become fixed and stable on the floor each with two crossing pipes firmly placed in their respective pipe cases. The entrance diameter of the pipe cases is slightly smaller or identical with the diameter of the grid pipes, in this way with a little effort one can force the pipe clamp over the pipes.

Subsequently—when you have forced the pipe clamp home
the pipes find a natural position in the respective pipe cases, because the diameter of the pipe cases can be slightly expanded (and has a half-round shape adapted to the physical shape of the pipes).

The reinforcement bars have various standard sizes—meaning diameters—depending of the building-type/room into which the floor heating is about to be installed. The pipe clamps exist in all dimensions, including no-common sizes.

The pipe clamps are placed most firmly at the cross fields but the pipe cases have an efficient clip-function, therefore the pipe clamp can be used everywhere to fix the pipes and, with advantage, you can use the pipe cases at the edges of the grid especially where the pipes are bended 180 grades—in the outermost bending position. At this outermost position their will be a big pressure on the pipe and for practical reasons you will place a pipe case here.

In spite of the lack of support from a crossing reinforcement bar (which a position in cross field would accomplish) the pipe clamp is firmly in position also outside the cross fields exclusively because of the construction and a crafty performance.

Even though the description of the respective pipe cases above comes as one of the last claims, the description has this very succession to accomplish the reader the full understanding of the pipe case's many finesses.

The present invention is characterized by slits which have been made in strategic places which accomplish that the pipe clamp becomes very flexible especially toward heavy weight because the slits accomplished obligingness towards the weight in the form of less rigidity and mobility of the joints.

It is obvious—as the slits increase the flexibility—that the block is easy to bring in position.

The possible increased freedom of movement for the pipe cases makes it easy to bring the clamp in position without the need of much effort to squeeze the clamp in position.

The top of the pipe clamp is shaped so it is prepared for the placing of the heat pipes in a bearing. Remark the bearing has an advantage because it is arranged as a perpendicular cross bearing.

In this way an advantage is obtained in that the heat pipes can be arranged in any angel needed.

When two pipes have been joined together by welding, there will be physical remains from the weld on the welded joint, on which you will find a minor rise. The same scenario goes for a welding on a reinforcement grid.

In the cross fields these rises will appear and exactly this condition has been taken into consideration in the design of the pipe clamp. Where the cross field will come into position in the pipe clamp, space has been provided for the rise [8] determined by the physical remains from the weld because of the cavity. None of the two German references have this rise- construction, even though they have space for the physical remains from the welding, it is not in form of a rise, but only as a lot of horizontal space.

This method of construction leads to making the fixation of the reinforcement bars even more unstable, because the physical remains from the welding will accomplish a inexpedient pressure on the reinforcement bar leading to a unstable bearing.

### DRAWING

FIG. 1 shows a pipe clamp seen from a sloping angle.

FIG. 2 shows a pipe clamp placed on one side.

FIG. 3 shows a pipe clamp seen from below.

FIG. 4 shows a pipe clamp seen from a side

FIG. 5 shows a pipe clamp seen from the top

### REFERENCE NUMBERS

1. a pipe case
2. narrow entrance opening to a pipe case
3. flexible slits
4. bearing for heat transporting pipe at the top of the pipe clamp [opportunity for placing pipes either in one or the opposite direction—the two directions are in a perpendicular position to each other]
5. bearing for the next reinforcement grid
6. lowest against the floor lying pipe case
7. topmost from the floor lying pipe case
8. a case for the remains from the weld

Below the pipe clamp will be presented with visual examples on every protective-worthy initiative.

When you have a number in brackets [ ] it refers to all relevant figures number-reference.

The pipe clamp will be presented in five different figurers in varies positions and perspectives.

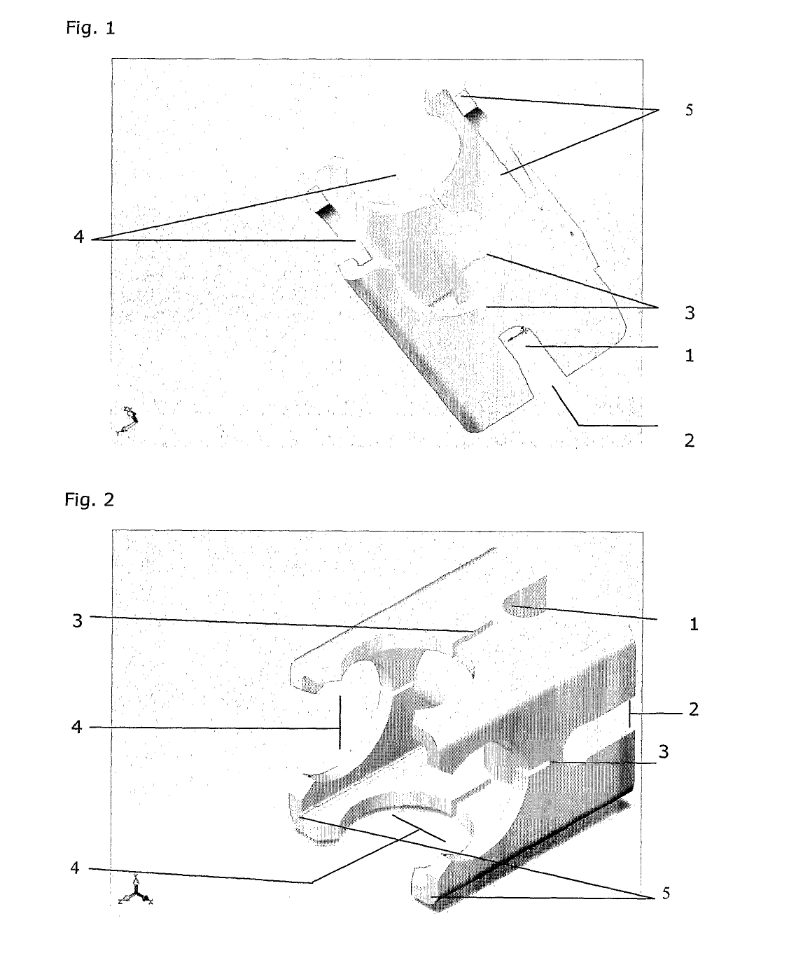

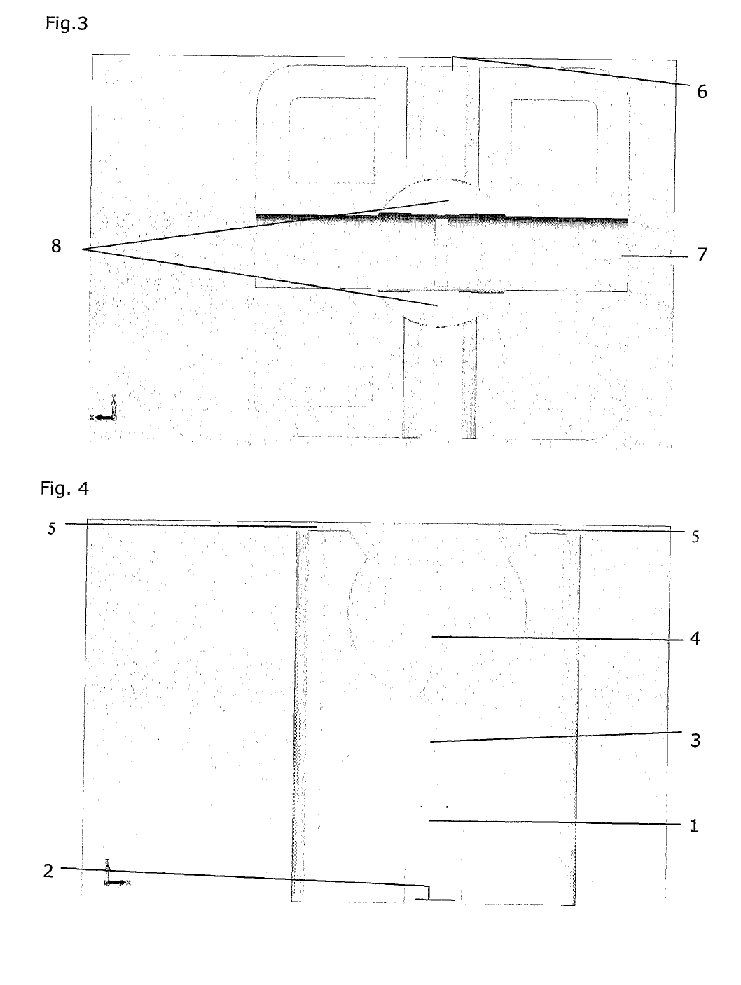

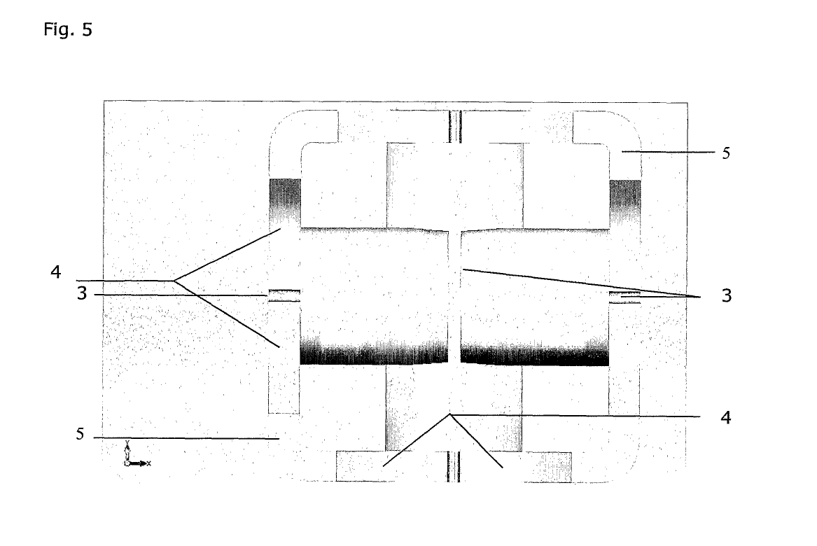

FIG. 1 shows a pipe clamp seen from a sloping angel, FIG. 2 shows a pipe clamp placed on one side. FIG. 3 shows a pipe clamp seen from below. FIG. 4 shows a pipe clamp seen from a side, finally FIG. 5 illustrates a pipe clamp seen from the top.

When the pipe clamp is pressed down over one of the cross fields of a reinforcement grid, the reinforcement bars will be steady positioning in their respective pipe cases [1] each with a dedicated diameter of their entrance [2] diameter foreseen for the size of the actually used pipes.

The entrance [2] to the pipe cases [1] has a diameter equal to the reinforcement bars or a slightly smaller diameter, whereby you need a minor pressure to bring the pipe clamp into position. In this way the reinforcement bar gains an optimal fasten of the respective pipe cases [1], and also a major stability.

It is important to emphasize that the use of the pipe clamp is not limited by the use of the cross field of the reinforcement grids, the pipe clamp can be placed freely to fix the reinforcement grids. Even though the stability is reduced a bit compared to the fixation at the cross fields—because only one of the pipe cases [1] supports the pipe clamp—the obtained stability is most sufficient because of the brilliant method of construction. The quadrangular shape and the design of the pipe cases and the heaviness from the weight of the heat transporting pipes and other material on top of the pipe clamp guarantee an optimal stability. To achieve a major flexibility and elasticity the pipe clamp is fit with what in this context is named slits [3] The slits [3] are incorporated at strategic places on the pipe clamp, in this way the consequences of heavy charge on the pipe clamp will become insignificant, the rigidity is prevented and the stability is preserved.

It is important to emphasize that use of the pipe clamp not is limited the use at the cross field of the reinforcement grids, the pipe clamp can be placed freely to fix the reinforcement grids. Even though the stability is reduce a bit compared to the fixation at the cross fields—because it is only one of the pipe cases [1] witch supports the pipe clamp—the obtained stability is most sufficient because of the brilliant method of construction. The quad angularly shape and the design of the pipe cases and the heaviness you have from the weight of the heat transporting pipes and other material on top of the pipe clamp guarantee an optimal stability. To achieve a major flexibility and elasticity the pipe clamp is fit with—what in this context is named slits [3].

The slits [3] is incorporate at strategic places on the pipe clamp, in this way the consequences of heavy charge on the pipe clamp will become insignificant, the rigidity is prevented and the stability is preserved.

The slits [3] are placed centrally in the middle of each of the four sides of the pipe clamp and also central at the top positioned half-round pipe case [1] in the pipe clamp.

The top of the pipe clamp has a special design purposed for a stable bearing [4] for the heat transporting pipes. The bearings [4] are in a crossed position and are in a perpendicular position to each other witch gives the opportunity for placing pipes either in one or the opposite direction of the two possible directions.

This extra possibility is a very practical finesse witch makes the pipe clamp practicability optimal.

Because the distance from the floor to the respective reinforcement bars naturally is staggered the pipe cases physical distance from the floor is adapted these conditions in this way one pipe case (FIG. 3.5) is at a higher position above the floor than the other (FIG. 3.6).

Hereby the pipe clamp occur steady fixed and stable placed on the floor with the two crossing pipes firmly placed in their respective pipe cases.

When two pipes have been joined together by welding, there will be physical remains from the weld on the welded joint, on which you will find a minor rise. The same scenario goes for a welding on a reinforcement grid. In the cross fields these rises will appear and exactly this condition has been taken into consideration in the design of the pipe clamp.

Where the cross field will come into position in the pipe clamp, space has been provided for the rise determined by the physical remains from the weld because of the cavity (FIG. 3.7).

The pipe clamp will be produced in dimensions and varieties suitable for the different standard sizes of reinforcement grid.

Further there will be a need for the production of no-common sizes pipe clamps, as most specialist in the field are aware of, that even if most reinforcement bars observance the standard dimension it is inevitable that some of the reinforcement bars are defective in respect to the standard dimension. Therefore pipe clamps will be produced to cover this kind of scenarios.

Further because of the choice of material and the method of construction, the pipe clamps are very tolerant in respect to minor deviation in the diameter of the reinforcement bars.

1. Pipe clamp preferably used in floor heating installations, where the pipe clamp is fixed on a reinforcement grid characterized in that the pipe clamp has a number of slits [3] in particular places centrally situated in the middle of each of the four sides [1] of the pipe clamp and also in the very center of the pipe clamp [1], and the pipe clamp is constructed as a very firm quadrangularly shaped block preferably made of polyfiner.pom

2. Pipe clamp according to claim 1 characterized in that the depth and length of the pipe cases [1] are adapted to cross mounted pipes of the reinforcement grid mutually different distance from the floor and the entrance diameter [2] for the pipe cases [1] is slightly smaller or identical to the diameter of the reinforcement grid pipes, further the diameter in the bottom of the pipe cases is slightly expanded leading to a half-round shape adapted to the physical shape of the pipe cases, in this way the above mentioned conditions together with the quadrangular shape of the pipe case imply that the pipe case also can be placed steadily anywhere but under the cross field of the reinforcement grid.

3. Pipe clamp according to claim 2 characterized in that where the cross field will come into position in the pipe clamp, space has been provided for the rise [8] determined by the physical remains from the weld because of the cavity (FIG. 3.8).

4. Pipe clamp according to claim 3 characterized in that the top of the pipe clamp is shaped so that it is prepared for the placing of the heat pipes in a bearing [4], arranged as two (arbitrary) on one another perpendicular cross bearings [4] and where the bearings or the groove for the pipes have a dimension so that the next layer of reinforcement bars, which are to be placed on top of the blocks, do not have direct physical contact on the pipes, but are resting on the top [5] of the blocks.
